(19) United States
(12) Patent Application Publication
(10) Pub. No.: US 2020/0211210 A1
(43) Pub. Date: Jul. 2, 2020

(54) INTERSECTION OF POINT CLOUD AND IMAGE TO DETERMINE RANGE TO COLORED LIGHT SOURCES IN VEHICLE APPLICATIONS

(71) Applicant: GM Global Technology Operations LLC, Detroit, MI (US)

(72) Inventors: Joseph Kampeas, Ramat Gan (IL); Nadav Lavi, Ramat-Hasharon (IL); Nimrod Gradus, Giva'atayim (IL)

(21) Appl. No.: 16/238,106

(22) Filed: Jan. 2, 2019

(51) Int. Cl. G06T 7/50; G06T 7/90; G01S 13/86; G01S 17/02; G01S 17/93; G01S 13/93; G01S 7/00

(52) U.S. Cl. CPC G06T 7/50; G06T 7/90; G01S 13/867; G01S 17/023; G06T 2207/10024; G01S 13/931; G01S 7/003; G06T 2207/10028; G01S 17/936

(57) ABSTRACT

A vehicle and method involve a first sensor obtaining an image, and a second sensor obtaining a point cloud. Each point of the point cloud indicates a range to a reflector. A determines a range from the vehicle to one or more light sources of a particular color based on an intersection of data from the image and data from the point cloud.

### INTRODUCTION

The subject disclosure relates to the intersection of a point cloud and an image to determine the range to colored light sources in vehicle applications.

Sensors (e.g., cameras, radio detection and ranging (radar) systems, light detection and ranging (lidar) systems) are increasingly used to augment or automate the operation of vehicles (e.g., automobiles, trucks, construction equipment, farm equipment, automated factor equipment). In addition to obtaining information from sensors, vehicles can also obtain information from other vehicles via vehicle-to-vehicle (V2V) communication or from infrastructure or other sources via vehicle-to-everything (V2X) communication. Vehicles can provide information via V2V or V2X communication, as well. Accordingly, it is desirable to provide the intersection of a point cloud and an image to determine a range to colored light sources in vehicle applications.

### SUMMARY

In one exemplary embodiment, a vehicle includes a first sensor to obtain an image, and a second sensor to obtain a point cloud. Each point of the point cloud indicates a range to a reflector. A controller determines a range from the vehicle to one or more light sources of a particular color based on an intersection of data from the image and data from the point cloud.

In addition to one or more of the features described herein, the second sensor is a radar system.

In addition to one or more of the features described herein, the second sensor is a lidar system.

In addition to one or more of the features described herein, the first sensor is a camera, and the data from the image is a matrix of pixels with each pixel indicating values for red, green, and blue (RGB) levels.

In addition to one or more of the features described herein, the controller determines the range to each of the one or more light sources based on an iterative process considering one pixel of the matrix of pixels per iteration.

In addition to one or more of the features described herein, the controller determines the range from the vehicle to one of the one or more light sources as the range to the reflector that corresponds to the one pixel based on the point of the point cloud corresponding with the reflector intersecting with a plane defined by the one pixel.

In addition to one or more of the features described herein, the controller determines that the one pixel is associated with one of the one or more light sources based on transforming the RBG level of the one pixel to a luminance value and comparing the luminance value with a threshold luminance value.

In addition to one or more of the features described herein, the particular color is red, and the controller determines that the one pixel is associated with one of the one or more light sources of the particular color based on comparing a ratio of the value for red to a sum of the values for red, green, and blue with a threshold color value.

In addition to one or more of the features described herein, the controller controls an operation of the vehicle based on the range from the vehicle to the one or more light sources.

In addition to one or more of the features described herein, the controller transmits the range to the one or more light sources to another vehicle or to infrastructure.

In another exemplary embodiment, a method includes obtaining an image using a first sensor of a vehicle, and obtaining a point cloud using a second sensor of the vehicle. Each point of the point cloud indicates a range to a reflector. The method also includes determining, using a controller, a range from the vehicle to one or more light sources of a particular color based on an intersection of data from the image and data from the point cloud.

In addition to one or more of the features described herein, the obtaining the point cloud includes using a radar system as the second sensor or using a lidar system as the second sensor.

In addition to one or more of the features described herein, the method also includes obtaining the data from the image includes obtaining a matrix of pixels with each pixel indicating values for red, green, and blue (RGB) levels, wherein the obtaining the image includes using a camera as the first sensor.

In addition to one or more of the features described herein, the determining the range to each of the one or more light sources includes performing on an iterative process that considers one pixel of the matrix of pixels per iteration.

In addition to one or more of the features described herein, the determining the range from the vehicle to one of the one or more light sources is as the range to the reflector that corresponds to the one pixel based on the point of the point cloud corresponding with the reflector intersecting with a plane defined by the one pixel.

In addition to one or more of the features described herein, the method also includes determining that the one pixel is associated with one of the one or more light sources based on transforming the RBG level of the one pixel to a luminance value and comparing the luminance value with a threshold luminance value.

In addition to one or more of the features described herein, the method also includes determining that the one pixel is associated with one of the one or more light sources of the particular color based on the particular color being red and comparing a ratio of the value for red to a sum of the values for red, green, and blue with a threshold color value.

In addition to one or more of the features described herein, the method also includes controlling an operation of the vehicle based on the range from the vehicle to the one or more light sources.

In addition to one or more of the features described herein, the method also includes transmitting the range to the one or more light sources to another vehicle or to infrastructure, wherein the first sensor, the second sensor, and the controller are in the vehicle.

In addition to one or more of the features described herein, the method also includes the another vehicle determining the range to the one or more light sources from the another vehicle based on a relative location of the vehicle.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a block diagram of a vehicle that can determine the intersection of a point cloud and an image to determine a range to colored light sources;

FIG. 2 illustrates a projection algorithm that facilitates determination of range to colored light sources based on a point cloud and an image according to one or more embodiments; and

FIG. 3 is a process flow of a method of identifying and locating colored light sources in a vehicle based on determining the intersection of a point cloud and an image according to one or more embodiments.

### DETAILED DESCRIPTION

The following description is merely exemplary in nature and is not intended to limit the present disclosure, its application or uses. It should be understood that throughout the drawings, corresponding reference numerals indicate like or corresponding parts and features.

As previously noted, a vehicle may use sensors like cameras, lidar systems, or radar systems, to detect objects within the field of view of the vehicle. In addition, a vehicle may use V2V or V2X communication to provide or obtain information regarding traffic conditions and other situations that affect travel. Sensor fusion, which refers to combining data from two or more sensors, generally involves increasing the total volume of data based on the combination.

Embodiments of the systems and methods detailed herein relate to the intersection of a point cloud and an image to determine a range to colored light sources in vehicle applications. Specifically, a point cloud, obtained using a lidar or radar system, and an image obtained with a camera are intersected to identify the range to colored light sources (e.g., tail lights that are the sources of red light). That is, the camera image facilitates identification of a colored light source while the point cloud obtained by a radar or lidar system facilitates determination of range to the colored light source. Unlike typical sensor fusion, the intersection results in a sparser data set than the image or point cloud by itself. This sparse information can be shared via V2V or V2X communication with low latency. A receiving entity may determine the location or range to the colored light sources.

In addition, the detecting or receiving vehicle may determine the context of the colored lights to augment or automate vehicle operation. The determination may be of a state of another vehicle (e.g., red tail lights indicate braking) or type of another vehicle (e.g., shape, size, height of tail light may indicate SUV, sedan, bus). The determination may be based on the relative height of the colored lights (e.g., lights on the roof indicate a police car or an ambulance). The determination may be based on the number of colored lights (e.g., large number of red lights indicate a traffic jam). Receiving the intersection information from another vehicle may provide insight into a scenario for which the receiving vehicle has no line-of-sight itself. When the receiving vehicle has partial line-of-sight to the scene from which it is receiving information, it can determine the relative position of the vehicle that sent the information from the induced geometry of the mutual light sources (i.e., light sources visible to both the sending and receiving vehicles). The exchange of the information in real-time may facilitate dynamic real-time mapping to identify the location of traffic jams or emergency vehicles, for example. This information may facilitate re-routing or clearing the path for an approaching emergency vehicle, for example.

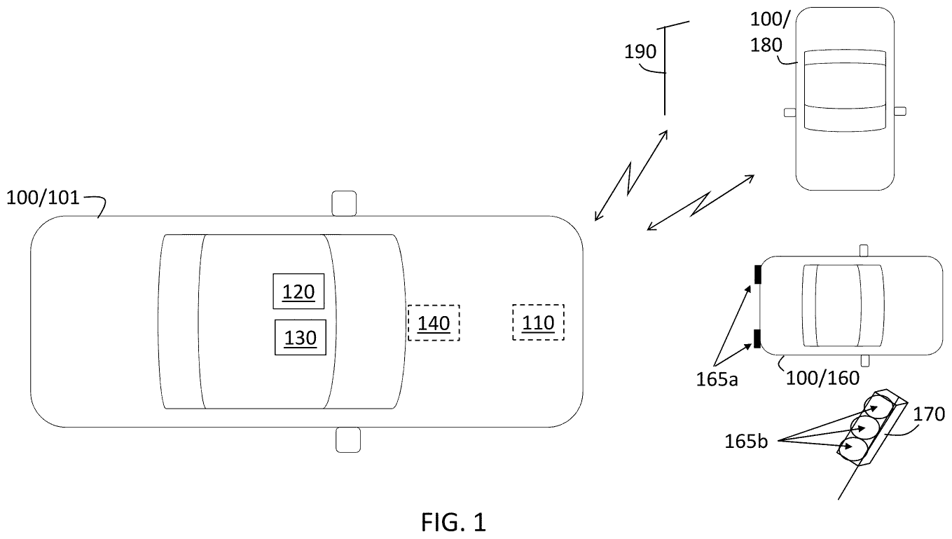

In accordance with an exemplary embodiment, FIG. 1 is a block diagram of a vehicle 100 that can determine the intersection of a point cloud and an image to determine a range to colored light sources 165. The vehicle 100 shown in FIG. 1 is an automobile 101. The exemplary vehicle 100 includes the following sensors: a radar system 110, a lidar system 120, and a camera 130. According to alternate embodiments, the vehicle 100 may include a radar system 110 or lidar system 120 but not both. Either the radar system 110 or lidar system 120 or both may provide a point cloud. A point cloud refers to a three-dimensional set of points that represent reflections obtained based on transmissions. In the case of the radar system 110, the transmission is from a radio frequency source, and in the case of the lidar system 120, the transmission is from a light source. Each point of the point cloud indicates range to the associated reflector. Thus, by using known processing techniques, the radar system 110 or lidar system 120 may be relied on for range information. The camera 130 provides images. Specifically, the image may be a matrix (i.e., two-dimensional array) of pixel values. Each pixel value may indicate an intensity level of red (R), green (G), and blue (B) or RGB associated with the pixel.

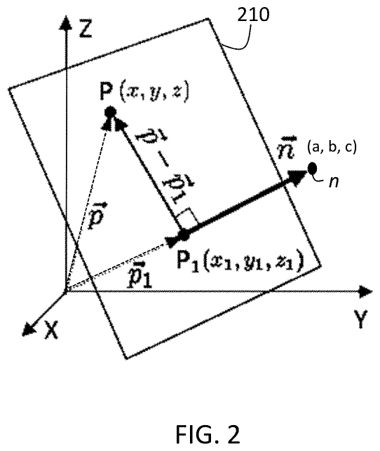

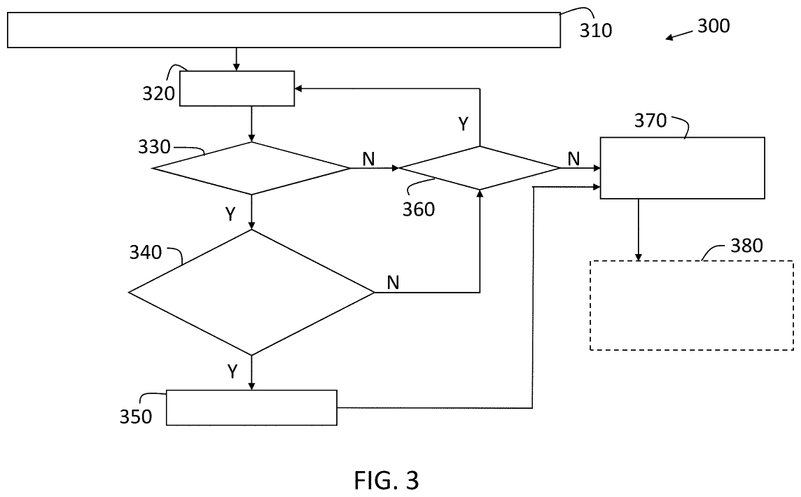

The vehicle may also include one or more controllers 140 (e.g., electronic control units (ECUs)). The controller 140 may process data from the sensors. As further discussed with reference to FIGS. 2 and 3, the processing of data from the sensors may include determining the intersection of a point cloud (obtained by the radar system 110 or lidar system 120) and an image (obtained by the camera 130) to identify colored light sources 165. In addition, the controller 140 may perform autonomous driving or control various aspects of the operation of the vehicle 100 (e.g., braking, steering). While exemplary locations are indicated in FIG. 1 for the radar system 110, lidar system 120, camera 130, and controller 140, those components may be located elsewhere in or on the vehicle 100 according to alternate embodiments.

The controller 140 may also communicate via V2V or V2X communication. For example, the controller 140 may communicate via V2V communication with other vehicles 100 like the other automobile 180. The controller 140 may also perform V2X communication with infrastructure 190. According to one or more embodiments, information communicated to and from the controller 140 of the automobile 101 may include range information about colored light sources 165. Exemplary colored light sources 165 shown in FIG. 1 include the braking lights 165a of a vehicle 100 that is an automobile 160 in front of the automobile 101 and different colored lights 165b of a traffic light 170. To perform the functionality described for the controller 140, the controller 140 may include processing circuitry and other components. The processing circuitry of the controller 140 may include an application specific integrated circuit (ASIC), an electronic circuit, a processor (shared, dedicated, or group) and memory that executes one or more software or firmware programs, a combinational logic circuit, and/or other suitable components that provide the described functionality.

FIG. 2 illustrates a projection algorithm that facilitates determination of a range to colored light sources 165 based on a point cloud and an image according to one or more embodiments. As previously noted, detection of colored light sources 165 facilitates augmented or automated action by the detecting vehicle 100 based on determining the context of the detected colored lights, as further discussed with reference to FIG. 3. Alternately or additionally, detection of colored light sources 165 also facilitates information sharing with other vehicles 100 or devices (e.g., infrastructure 190). For example, a vehicle 100 with a controller 140 that identifies colored light sources 165 may alert other vehicles 100 in the area of an approaching ambulance or fire truck using V2V communication. The alert may facilitate clearing of traffic for faster passage of the ambulance or fire truck. As another example, a vehicle 100 with a controller 140 that identifies colored light sources 165 may provide information to infrastructure 190 about slowing or stopped traffic via V2X communication. This information may then be used for traffic management or driver alerts.

FIG. 2 shows a plane 210 on which pixels of the image obtained by the camera 130 may lie. A vector \vec{n} represents the orientation of the camera 130 and is normal to the plane 210, which represents the image (i.e., the vehicle 100 point of view), and the point P1 is a known point on the plane 210 (i.e., the camera 130 calibration point). As indicated in FIG. 2, the point P1, which is the terminal point for vector \vec{P1}, is defined by x1, y1, and z1, and the terminal point n of vector \vec{n} is defined by a, b, c. Accordingly, for any point P on the plane (i.e., for any pixel of the image) whose terminal point is defined by x, y, z, a vector on the plane 210 that connects the known point P1 and the point P (i.e., the given pixel) may be defined as:

\vec{P}−\vec{P1}=(x−x1,y−y1,z−z1) [EQ. 1.]

As FIG. 2 indicates, the vector in EQ. 1 (i.e., the vector that connects P1 and P) is perpendicular to the vector \vec{n}. Thus, by definition, the dot product of the two vectors must be 0. That is:

\vec{n}·(\vec{P}−\vec{P1})=0 [EQ. 2]

Using EQ. 1, the dot product in EQ. 2 may be expanded as follows:

(a,b,c)·(x−x1,y−y1,z−z1)=0 [EQ. 3]

a(x−x1)+b(y−y1)+c(z−z1)=0 [EQ. 4]

ax+by+cz−(ax1+by1+cz1)=0 [EQ. 5]

Then, by defining a constant d=(ax1+by1+cz1), EQ. 5 may be re-written as the plane equation:

ax+by+cz−d=0 [EQ. 6]

By recognizing that ax+by+cz is the dot product of the vectors \vec{n} and \vec{P}, for any point P on the plane 210, the image plane 210 may be described by EQ. 6, which may be re-written as:

\vec{n}·\vec{P}=d [EQ. 7]

With EQ. 7 defining the plane 210, a parametric segment equation given by S(t)=A+t(B−A) with 0≤t≤1 can be considered to describe a point cloud reflection vector of length B−A, where A(x_{A},y_{B},z_{C}) is the position of the radar 110 or lidar 120, and B(x_{B},y_{B},z_{B}) is the point of reflection. By substituting the parametric segment (i.e., vector \vec{s}) for \vec{P} in the plane equation of EQ. 7, it can be determined if there is a valid value of t (i.e., t between 0 and 1) for which EQ. 7 holds true. This would mean that the point from the point cloud intersects the plane defined by the pixel. Then, EQ. 7, with vector \vec{s} substituted for \vec{P}, could be written:

\vec{n}·\vec{s}=d [EQ. 8]

EQ. 8 may be re-written as:

\vec{n}·(A+t(B−a))=d [EQ. 9]

EQ. 9 may be solved for t as:

$$t = \frac{d - \vec{n} \cdot A}{\vec{n} \cdot ( B - A )} \qquad [ EQ . 10 ]$$

As previously noted, if the value of t is between 0 and 1, then the plane 210 and the point from the point cloud intersect, and the point from the point cloud provides the range associated with the pixel.

FIG. 3 is a process flow 300 of a method of identifying and locating colored light sources 165 from a vehicle 100 based on determining the intersection of a point cloud and an image according to one or more embodiments. The processes at blocks 320 through 370 may be performed by the controller 140 of the vehicle 100. At block 310, obtaining a point cloud and image data from two or more sensors includes obtaining a point cloud from a lidar system 120 or radar system 110 and image data (i.e., pixels) from a camera 130. At block 320, selecting a pixel refers to selecting a new pixel from the image data (obtained at block 310) for each iteration. At block 330, a check is done of whether there is an intersection between the selected pixel and the point cloud. Essentially, EQ. 10 is used to obtain t that identifies the pixel position in the image. If the value of t is between 0 and 1, then it is determined, at block 330, that there is an intersection.

If it is determined, at block 330, that there is an intersection between the selected pixel and the point cloud, a check is done, at block 340, of whether the pixel portion of the image is colored red and is a light source. The pixel will have values from 0 to one for each of R (red), G (green), and B (blue). Thus, to determine whether the pixel is colored red, the following may be checked:

$$\frac{R}{R + B + G} > threshold 1 \qquad [ EQ . 11 ]$$

The value of threshold1 may be 1 or less. For example, if the pixel were completely red, then the (R, G, B) representation of the pixel would be (255, 0, 0). In that case, the ratio in EQ. 11 would be 1. The threshold1 value may be set to a value below 1 to capture pixels that are mostly but not entirely red. To determine whether the pixel is associated with a light source, a known transformation from RGB values to luminance may be used along with a threshold value threshold2 for the resulting luminance. Thus, the following may be checked:

(0.3R+0.58G+0.11B)>threshold2 [EQ. 12]

If the checks at EQS. 11 and 12 are passed, at block 340, then the range value provided by the point cloud is stored as the range to a red light at block 350.

If, at block 330, it is determined that there is no intersection between the selected pixel and the point cloud or if, at block 340, it is determined that the pixel does not correspond with a red light, then a check is done, at block 360, of whether there are additional unselected pixels for further iteration. If so, then the processes at blocks 320 through 350 are repeated. If there are no additional pixels, then, at block 370, the range information stored at block 350 is used or disseminated via V2V or V2X communication. At block 380, the controller 140 may use the information stored at block 350 to augment or automate operation of the vehicle 100. Part of the processing at block 380 involves interpreting a context of the detected colored light sources 165. For example, the controller 140 may interpret a number of brake lights (i.e., a number of detected colored light sources 165) that is greater than a threshold number as indicating a traffic jam. Based on this interpretation, the controller 140 may re-route the vehicle 100. As another example, the controller 140 may interpret the height of the colored light source 165 to mean that an emergency vehicle is detected. Based on the relative position and direction of travel of the emergency vehicle, the controller 140 may take evasive action or broadcast a V2X message.

If the information stored at block 350 is disseminated to other vehicles 100 or to infrastructure 190, then the process at block 380 may be performed by the receiving entity. The infrastructure 190 may include or communicate with a cloud server. At block 380, determining relative position of the sending vehicle 100 with the receiving entity facilitates a determination of where the indicated red lights are relative to the receiving entity. Taking action, at block 380, may first include interpreting the context of the indicated colored light sources 165. That is, the processes performed by the receiving entity may include determining whether the received information indicates a traffic situation, an approaching emergency vehicle, or other scenario. The process flow shown in FIG. 3 is not limited to the order shown. In alternate embodiments, the order of the processes shown in FIG. 3 can be changed. For example, a determination can first be made of whether the selected pixel indicates a red light source (block 340) prior to determining whether there is a ranging value available for the pixel (block 330). In addition, by modifying EQ. 11, alternate or additional embodiments may relate to the identification and ranging to colored light sources 165 that are a color other than red.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A vehicle, comprising:
a first sensor configured to obtain an image;
a second sensor configured to obtain a point cloud, wherein each point of the point cloud indicates a range to a reflector; and
a controller configured to determine a range from the vehicle to one or more light sources of a particular color based on an intersection of data from the image and data from the point cloud.

2. The vehicle according to claim 1, wherein the second sensor is a radar system.

3. The vehicle according to claim 1, wherein the second sensor is a lidar system.

4. The vehicle according to claim 1, wherein the first sensor is a camera, and the data from the image is a matrix of pixels with each pixel indicating values for red, green, and blue (RGB) levels.

5. The vehicle according to claim 4, wherein the controller is configured to determine the range to each of the one or more light sources based on an iterative process considering one pixel of the matrix of pixels per iteration.

6. The vehicle according to claim 5, wherein the controller is configured to determine the range from the vehicle to one of the one or more light sources as the range to the reflector that corresponds to the one pixel based on the point of the point cloud corresponding with the reflector intersecting with a plane defined by the one pixel.

7. The vehicle according to claim 5, wherein the controller is further configured to determine that the one pixel is associated with one of the one or more light sources based on transforming the RBG level of the one pixel to a luminance value and comparing the luminance value with a threshold luminance value.

8. The vehicle according to claim 5, wherein the particular color is red, and the controller is further configured to determine that the one pixel is associated with one of the one or more light sources of the particular color based on comparing a ratio of the value for red to a sum of the values for red, green, and blue with a threshold color value.

9. The vehicle according to claim 1, wherein the controller is further configured to control an operation of the vehicle based on the range from the vehicle to the one or more light sources.

10. The vehicle according to claim 1, wherein the controller is further configured to transmit the range to the one or more light sources to another vehicle or to infrastructure.

11. A method, comprising:
obtaining an image using a first sensor of a vehicle;
obtaining a point cloud using a second sensor of the vehicle, wherein each point of the point cloud indicates a range to a reflector; and
determining, using a controller, a range from the vehicle to one or more light sources of a particular color based on an intersection of data from the image and data from the point cloud.

12. The method according to claim 11, wherein the obtaining the point cloud includes using a radar system as the second sensor or using a lidar system as the second sensor.

13. The method according to claim 11, further comprising obtaining the data from the image includes obtaining a matrix of pixels with each pixel indicating values for red, green, and blue (RGB) levels, wherein the obtaining the image includes using a camera as the first sensor.

14. The method according to claim 13, wherein the determining the range to each of the one or more light sources includes performing on an iterative process that considers one pixel of the matrix of pixels per iteration.

15. The method according to claim 14, wherein the determining the range from the vehicle to one of the one or more light sources is as the range to the reflector that corresponds to the one pixel based on the point of the point cloud corresponding with the reflector intersecting with a plane defined by the one pixel.

16. The method according to claim 14, further comprising determining that the one pixel is associated with one of the one or more light sources based on transforming the RBG level of the one pixel to a luminance value and comparing the luminance value with a threshold luminance value.

17. The method according to claim 14, further comprising determining that the one pixel is associated with one of the one or more light sources of the particular color based on the particular color being red and comparing a ratio of the value for red to a sum of the values for red, green, and blue with a threshold color value.

18. The method according to claim 11, further comprising controlling an operation of the vehicle based on the range from the vehicle to the one or more light sources.

19. The method according to claim 11, further comprising transmitting the range to the one or more light sources to another vehicle or to infrastructure, wherein the first sensor, the second sensor, and the controller are in the vehicle.

20. The method according to claim 19, further comprising the another vehicle determining the range to the one or more light sources from the another vehicle based on a relative location of the vehicle.
